(19) United States
(12) Patent Application Publication
(10) Pub. No.: US 2014/0289271 A1
(43) Pub. Date: Sep. 25, 2014

(54) SYSTEM, METHOD AND COMPUTER PROGRAM PRODUCT FOR INTEGRATING A MULTI-TENANT DATABASE SYSTEM AND A USER INFORMATION MANAGEMENT APPLICATION

(71) Applicant: salesforce.com, inc., San Francisco, CA (US)

(72) Inventors: Krzysztof Oblucki, Emeryville, CA (US); Kyle Haskins, Petaluma, CA (US); Russell Wells Dawson, Laveen, AZ (US); Oktyamir Zefas, Walnut Creek, CA (US); Ken Wakamatsu, San Francisco, CA (US)

(73) Assignee: salesforce.com, inc., San Francisco, CA (US)

(21) Appl. No.: 14/220,008

(22) Filed: Mar. 19, 2014

Related U.S. Application Data
(60) Provisional application No. 61/804,908, filed on Mar. 25, 2013.

(51) Int. Cl. G06F 17/30; G06F 21/62

(52) U.S. Cl. CPC G06F 17/30106; G06F 21/6227
USPC 707/769; 707/784

(57) ABSTRACT

In accordance with embodiments, there are provided mechanisms and methods for integrating a multi-tenant database system and a user information management application. These mechanisms and methods for integrating a multi-tenant database system and a user information management application can provide sharing of tenant data between the multi-tenant database system and the user information management application. The ability to provide such data sharing may further provide users with a more comprehensive multi-tenant database system and user information management application.

### CLAIM OF PRIORITY

This application claims the benefit of U.S. Provisional Patent Application No. 61/804,908 entitled “System and Method for Dynamic Integration of Multi-Tenant Database Records in E-Mail Clients,” by Wakamatsu et al., filed Mar. 25, 2013 (Attorney Docket No. SFC1P214+/1131PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to information management in an multi-tenant database system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Generally, a multi-tenant database system centrally stores data for multiple tenants, such that each tenant can access its own data at the central location. However, in many cases tenants may also store data in a system, application, etc. located remotely from the multi-tenant database system. For example, tenants may store some data in the multi-tenant database system, and may store other data in a separate client or server based application, such as an email application, etc.

Accordingly, it is desirable to provide techniques enabling integration of a multi-tenant database system and a user information management application.

### BRIEF SUMMARY

In accordance with embodiments, there are provided mechanisms and methods for integrating a multi-tenant database system and a user information management application. These mechanisms and methods for integrating a multi-tenant database system and a user information management application can enable embodiments to provide sharing of tenant data between the multi-tenant database system and the user information management application. The ability of embodiments to provide such data sharing may further provide users with a more comprehensive multi-tenant database system and user information management application.

In an embodiment and by way of example, a method for integrating a multi-tenant database system and a user information management application is provided. In use, a user selected item of information is received from an application utilized for managing information of the user. Additionally, a contact is identified from the user selected item of information. At least one record related to the contact is then retrieved from a multi-tenant database system separate from the application. Further, details of each retrieved record are presented in association with the application. A command is received from the user to store the item of information in the multi-tenant database system in association with at least one of the retrieved records. Still yet, an indication of the storage of the item of information in the multi-tenant database system is presented in association with the details of the at least one of the retrieved records.

While one or more implementations and techniques are described with reference to an embodiment in which integrating a multi-tenant database system and a user information management application is implemented in a system having an application server providing a front end for an on-demand database service capable of supporting multiple tenants, the one or more implementations and techniques are not limited to such multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for integrating a multi-tenant database system and a user information management application, in accordance with an embodiment;

FIG. 2 illustrates an exemplary graphical user interface (GUI) of an email application presenting details of records retrieved from a multi-tenant database system, in accordance with an embodiment;

FIG. 3 illustrates an exemplary GUI of an email application presenting an indication that an email from the email application has been stored in a multi-tenant database system, in accordance with an embodiment;

FIG. 4 illustrates an operational flow diagram for the logging in of a user of an email application to a multi-tenant database system, in accordance with an embodiment;

FIG. 5 illustrates an exemplary GUI enabling the user login to the multi-tenant database system described in FIG. 4, in accordance with an embodiment;

FIGS. 6A-B illustrate an operational flow diagram for updating a settings tab of an email application, in accordance with FIG. 4;

FIG. 7 illustrates an exemplary GUI illustrating the authorization window of FIG. 4 displayed in association with an email application, in accordance with an embodiment;

FIG. 8 illustrates an operational flow diagram for updating a settings tab of an email application, in accordance with an embodiment;

FIG. 9 illustrates an exemplary GUI of an email application presenting details of records retrieved from a multi-tenant database system, in accordance with an embodiment;

FIG. 10 illustrates an operational flow diagram for presenting an indication that an email of an email application has been stored in a multi-tenant database system, in accordance with an embodiment;

FIG. 11 illustrates an exemplary GUI of an email application presenting the indication of FIG. 10, in accordance with an embodiment;

FIG. 12 illustrates an exemplary GUI of an email application presenting an indication of a user session with a multi-tenant database system, in accordance with an embodiment;

FIG. 13 illustrates an operational flow diagram for logging in/out of a multi-tenant database system via an email application, in accordance with an embodiment;

FIG. 14 illustrates an operational flow diagram for allowing a user to configure a portion of an email application presenting details of records retrieved from a multi-tenant database system, in accordance with an embodiment;

FIG. 15 illustrates an exemplary GUI of an email application resulting from a collapsing of the portion of the email application described in FIG. 14, in accordance with an embodiment;

FIG. 16 illustrates an exemplary GUI of an email application for presenting an indication that an email of an email application will be automatically stored in a multi-tenant database system, in accordance with an embodiment;

FIG. 17 illustrates an exemplary GUI of a calendar application for presenting an option for storing an event of the calendar application in a multi-tenant database system, in accordance with an embodiment;

FIG. 18 illustrates a block diagram of an example of an environment wherein an on-demand database service might be used; and

FIG. 19 illustrates a block diagram of an embodiment of elements of FIG. 18 and various possible interconnections between these elements.

### DETAILED DESCRIPTION

### General Overview

Systems and methods are provided for integrating a multi-tenant database system and a user information management application.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing integrating a multi-tenant database system and a user information management application will be described with reference to example embodiments.

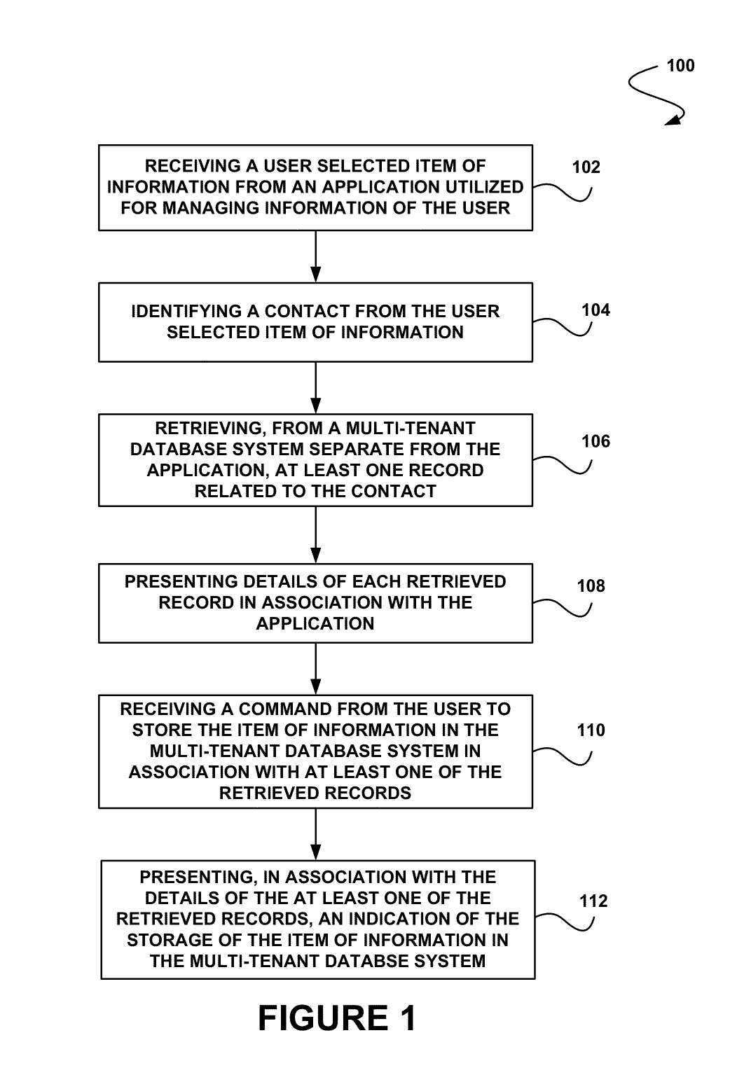

FIG. 1 illustrates a method 100 for integrating a multi-tenant database system and a user information management application, in accordance with an embodiment. As shown in operation 102, a user selected item of information is received from an application utilized for managing information of the user. In the context of the present description, the application utilized for managing information of the user may be any program or portion thereof capable of being utilized for managing information of the user. For example, the information of the user may be emails sent to the user and/or received by the user, tasks scheduled for the user, contacts of the user, etc.

In this way, the application may be an email application, such as a client-side application (e.g. Microsoft Outlook™, etc.) or a server-based application (e.g. Gmail™, etc.). In such a case, the user selected item of information may be an email stored by the email application. As another option, the application may be a calendar, where the item of information is a task stored by the calendar. As yet another option, the application may be contact directory, where the item of information is a contact entry in the contact directory. Of course, it should be noted that the application may be any combination of the aforementioned email, calendar, directory, etc. applications. Further, the present method 100 may be performed by the application or any other code integrated with the application (e.g. an add-on, etc. provided by the multi-tenant database system described below).

Additionally, as shown in operation 104, a contact is identified from the user selected item of information. The contact may be any identifier (e.g. email address, name, etc.) of a user, organization, or other entity that is included in the item of information selected by the user. For example, in the context of an item of information that is an email, the contact may be an entity identified in a TO: field of the email (i.e. to which the email was sent) or an entity identified in a FROM: field of the email (i.e. from which the email was sent). In other embodiments, the contact may be identified in subject text, attachments, message body, etc. of the email or other item of information.

At least one record related to the contact is then retrieved from a multi-tenant database system separate from the application, as shown in operation 106. The application may be provided one provider while the multi-tenant database system may be provided by another provider. Further, the application may be located remotely from the multi-tenant database system.

In the context of the present description, the multi-tenant database system may include at least one database that stores data in records for users of various tenants. Thus, the multi-tenant database system may optionally be used to manage the users' data, such that the aforementioned application and the multi-tenant database system may be used by the user to separately manage data of the user.

For example, the multi-tenant database system may store data in records for a user that is the contact, or for a user of a tenant that is the contact. In one embodiment, the multi-tenant database system may be queried using the contact, such that the record(s) may be retrieved as a response to the query. The records stored by the multi-tenant database system that may be retrieved for a particular contact may include a contact record storing information of the contact, an activity record storing a task of the contact, an opportunity record storing information of another contact (e.g. a sales lead) that is associated with the contact, an account record storing information of an account of the contact, a file record storing a file for the contact, etc. It should be noted that only records accessible to the user based on predefined permissions (e.g. configured in the multi-tenant database system) are retrieved from the multi-tenant database system. Optionally, the user may be required to login to, or otherwise authenticate himself with, the multi-tenant database system (e.g. via the application), prior to identifying the record(s). Such authentication may be used to determine the records accessible to the user.

Further, as shown in operation 108, details of each retrieved record are presented in association with the application. For example, information included in the retrieved records, a name of each of the retrieved records, a name of an entity represented by each of the retrieved records, etc. may be presented in a GUI of the application. In one optional embodiment, a GUI of the application may present the user selected item of information in a first portion of the GUI and the details of the retrieved records in a second portion of the GUI.

A command is received from the user to store the item of information in the multi-tenant database system in association with at least one of the retrieved records, as shown in operation 110. In one embodiment, the details of each of the retrieved records may include a selectable option to store the user selected item of information in the multi-tenant database system in association with such retrieved record. Thus, the user may select to store the item of information in the multi-tenant database system in association with any of the retrieved records. In another embodiment, the item of information may be automatically stored in the multi-tenant database system in association with any of the retrieved records in response to the user selecting (e.g. commanding) to create, save, send, etc. the item of information.

To this end, the item of information may be stored in the multi-tenant database system in association with at least one of the retrieved records, in response to receipt of the command. For example, the item of information may be stored in details of the retrieved record or in a separate record that is provided a relationship (e.g. link, reference, etc.) to the retrieved record.

Still yet, as shown in operation 112, an indication of the storage of the item of information in the multi-tenant database system is presented in association with the details of the at least one of the retrieved records. In other words, when the user commands that the item of information be stored in the multi-tenant database system in association with one of the retrieved records, the application may present the indication that the item of information was actually stored in the multi-tenant database system for that retrieved record. This indicator may allow the user to identify the retrieved records for which the item of information has already been stored, such that the user may avoid attempting to again store the item of information for those same retrieved records. Moreover, for each subsequent selection of the item of information by the user, the previously made association with the retrieved record may be identified in the multi-tenant database system and the aforementioned indication presented to the user, similarly for allowing the user to avoid attempting to again store the item of information for that same retrieved record.

By allowing the retrieval of multi-tenant database system records via the application, and further allowing via the application an item of information of the application to be stored in the multi-tenant database system in association with those retrieved records, the multi-tenant database system and the application may be integrated. For example, user data may be shared between the multi-tenant database system and the user information management application, which may provide users with a more comprehensive multi-tenant database system and user information management application.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

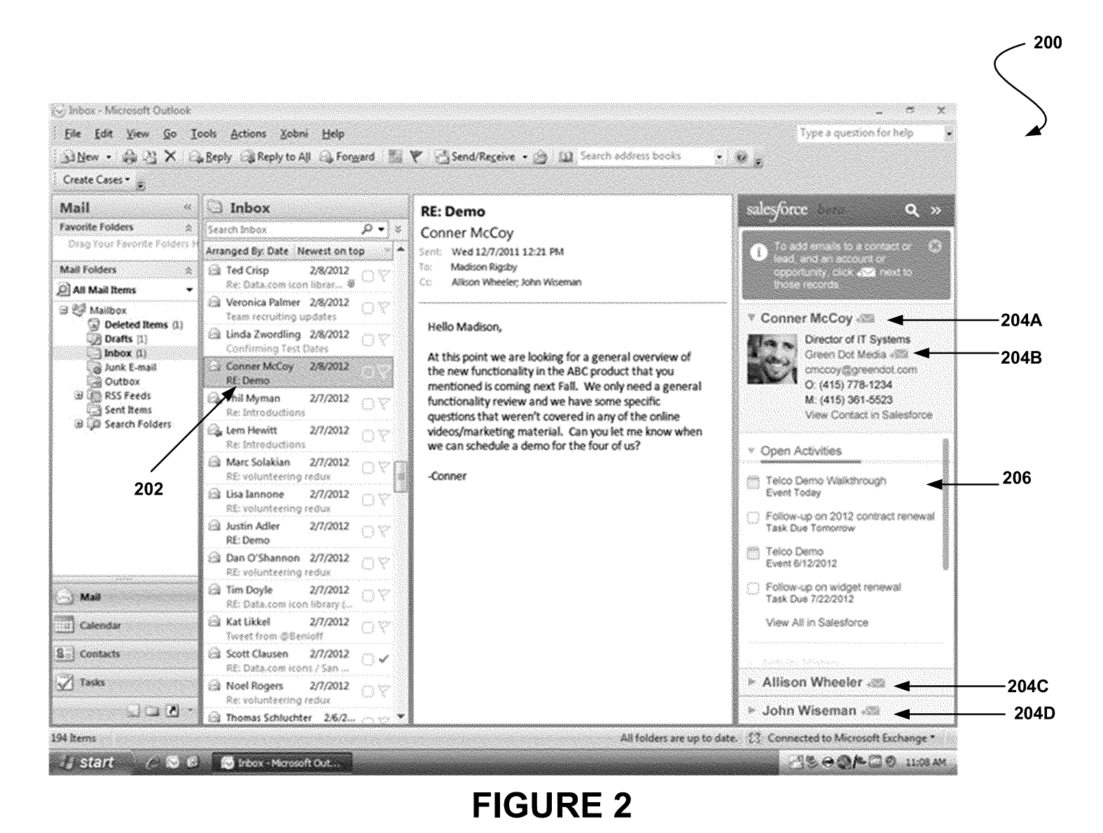

FIG. 2 illustrates an exemplary GUI 200 of an email application presenting details of records retrieved from a multi-tenant database system, in accordance with an embodiment. As an option, the present GUI 200 may be implemented in the context of the method 100 of FIG. 1. Of course, however, GUI 200 may be implemented in any desired environment. For example, while the GUI 200 is specific to an email application, it should be noted that any GUI with similar functionality may be provided for any user information management application that is integrated with a multi-tenant database system. It should also be noted that the aforementioned definitions may apply during the present description.

As shown, the GUI 200 includes a first portion (i.e. pane) for displaying emails of the user and for allowing the user to select one of the emails 202 for viewing the details thereof. The GUI 200 also includes a second portion (i.e. pane) for displaying records 204A-D and 206 retrieved from the multi-tenant database system.

In response to a user selection of one of the emails 202 from the first portion of the GUI 200, contacts may be identified from the email and records 204A-D and 206 related to those contacts may be retrieved from the multi-tenant database system for display thereof in the second portion of the GUI 200. As shown, the records 204A-D and 206 may be contact records 204A-D and activity records 206.

For each of the displayed contact records 204A-D, an option may be provided for the user to store the selected email in the multi-tenant database system in association with the contact record. Thus, selection of the option for a particular contact record 204A-D may result in the email being stored in the multi-tenant database system in association with that contact record. While not shown, it should be noted that the email may similarly be capable of being stored for any of the other records retrieved from the multi-tenant database system (e.g. the activity records 206).

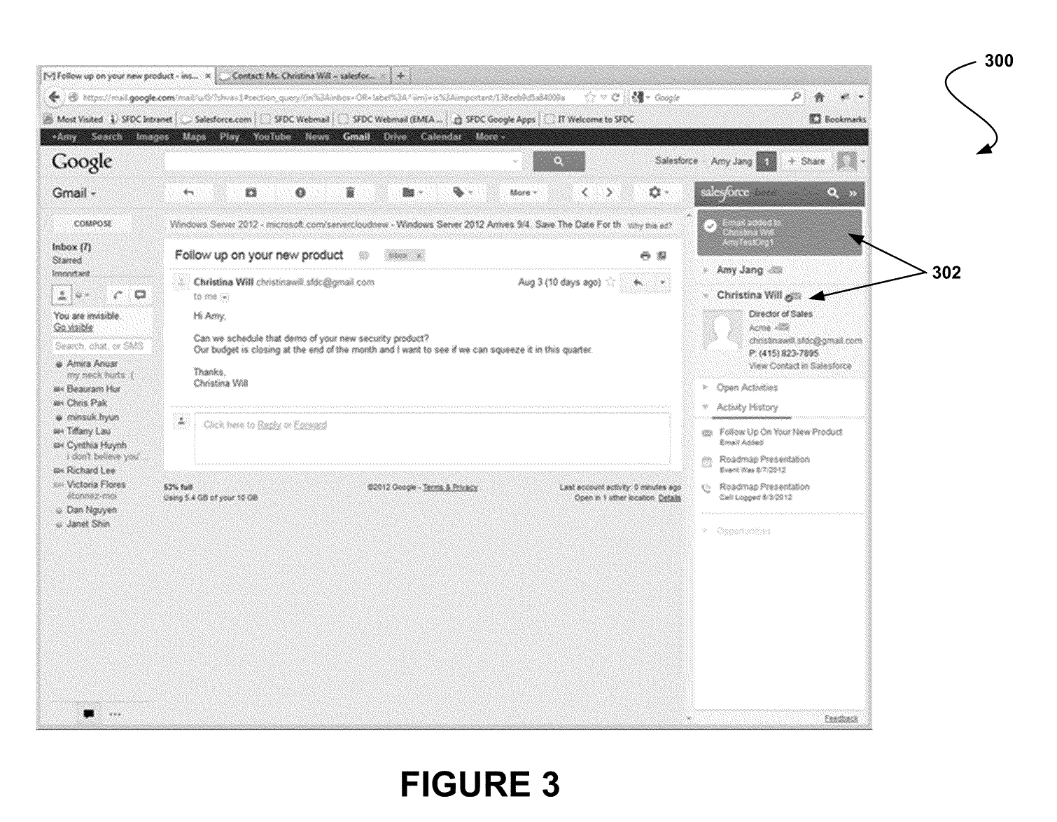

FIG. 3 illustrates an exemplary GUI 300 of an email application presenting an indication that an email from the email application has been stored in a multi-tenant database system, in accordance with an embodiment. As an option, the GUI 300 may be implemented in the context of FIGS. 1-2. Of course, however, the system GUI 300 may be implemented in any desired environment. It should also be noted that the aforementioned definitions may apply during the present description.

As shown, when an email is stored in the multi-tenant database system in association with a retrieved contact record, as commanded by the user, the email application may present the indication 302 that the item of information was stored in the multi-tenant database system for that retrieved record. This indicator may allow the user to identify the retrieved records for which the email has already been stored, such that the user may avoid attempting to again store the email for those same retrieved records. Moreover, for each subsequent selection of the email by the user in the email application, the previously made association with the retrieved record may be identified in the multi-tenant database system and the aforementioned indication presented to the user, similarly for allowing the user to avoid attempting to again store the email for that same retrieved record.

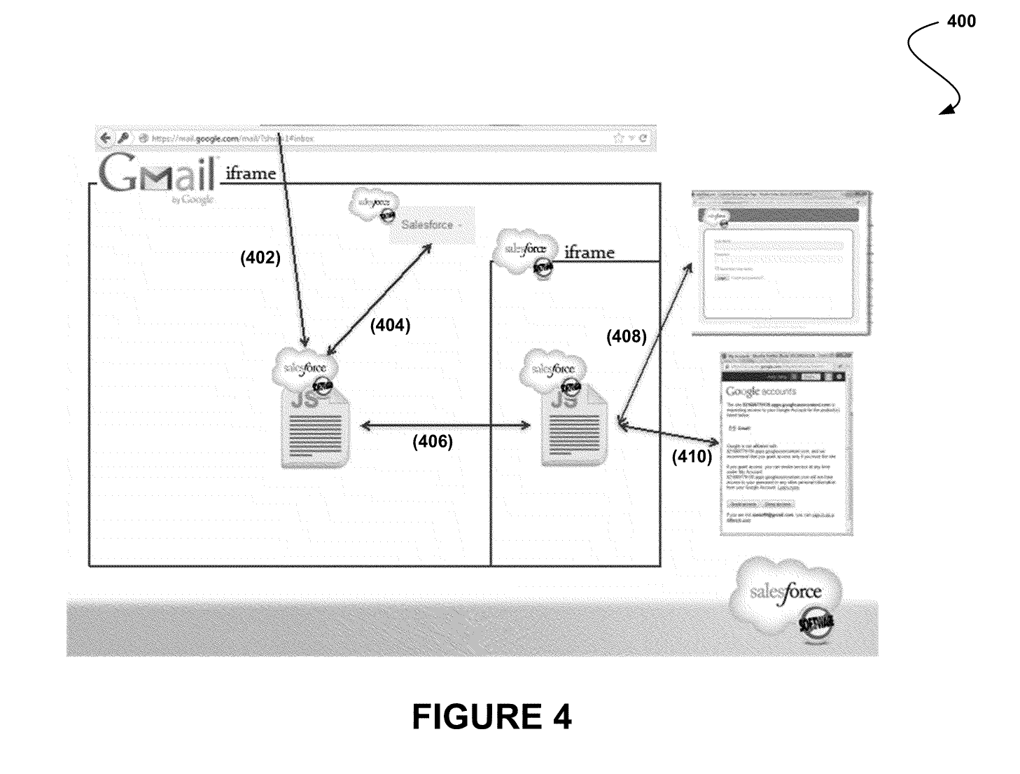

FIG. 4 illustrates an operational flow diagram 400 for the logging in of a user of an email application to a multi-tenant database system, in accordance with an embodiment. As an option, the present flow diagram 400 may be carried out in the context of FIGS. 1-3. Of course, however, the flow diagram 400 may be carried out in any desired environment. It should also be noted that the aforementioned definitions may apply during the present description.

As shown in operation 402, when a user is using an email application having a capability to integrate with a multi-tenant database system, a first component (e.g. add-on, script, etc.) of the email application is executed. The first component determines in operation 404 whether the user is logged into the multi-tenant database system (e.g. via a settings tab of the application showing any user currently logged into the multi-tenant database system). If it is determined that the user is not logged into the multi-tenant database system, then in operation 406 the first component directs a second component of the application to create a request to log the user into the multi-tenant database system. In response, the second component provides a login page to the user (operation 408). Once the user is logged into the multi-tenant database system via the login page, the second component further presents an authorization window for the user to accept the integration (operation 410).

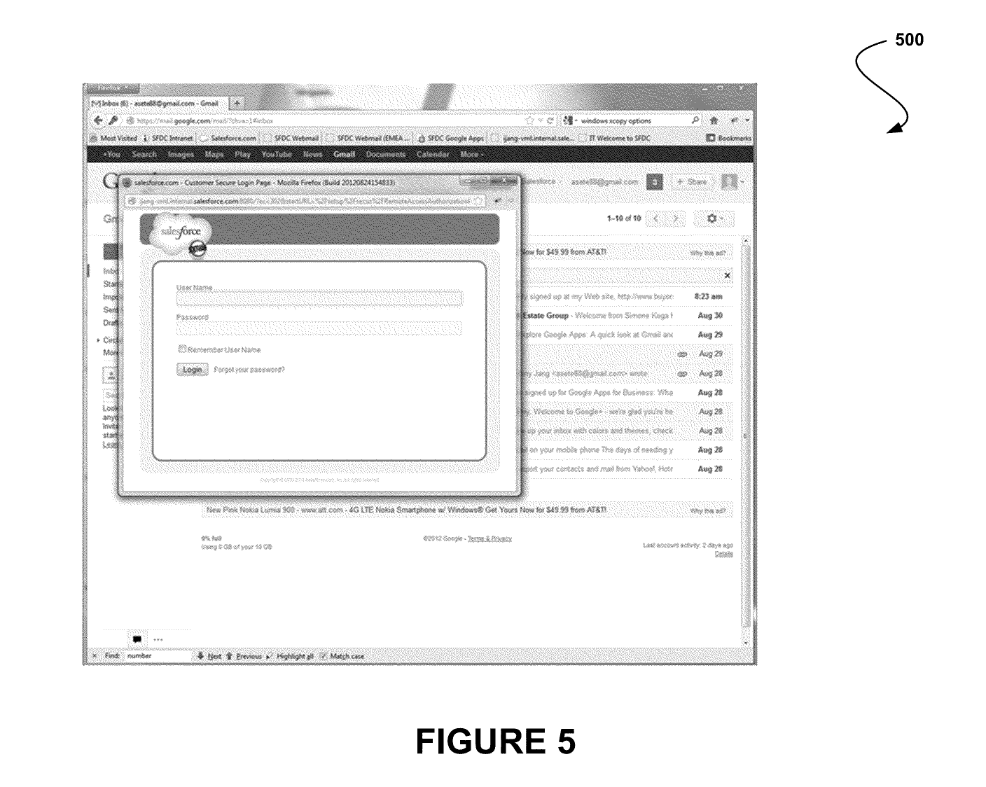

FIG. 5 illustrates an exemplary GUI 500 enabling the user login to the multi-tenant database system described in FIG. 4, in accordance with an embodiment. As shown, the application enables the user to login to the multi-tenant database system. The user may be required to login to the multi-tenant database system, and therefore authenticate himself with the multi-tenant database system, prior to allowing the user to access records of the multi-tenant database system via the email application.

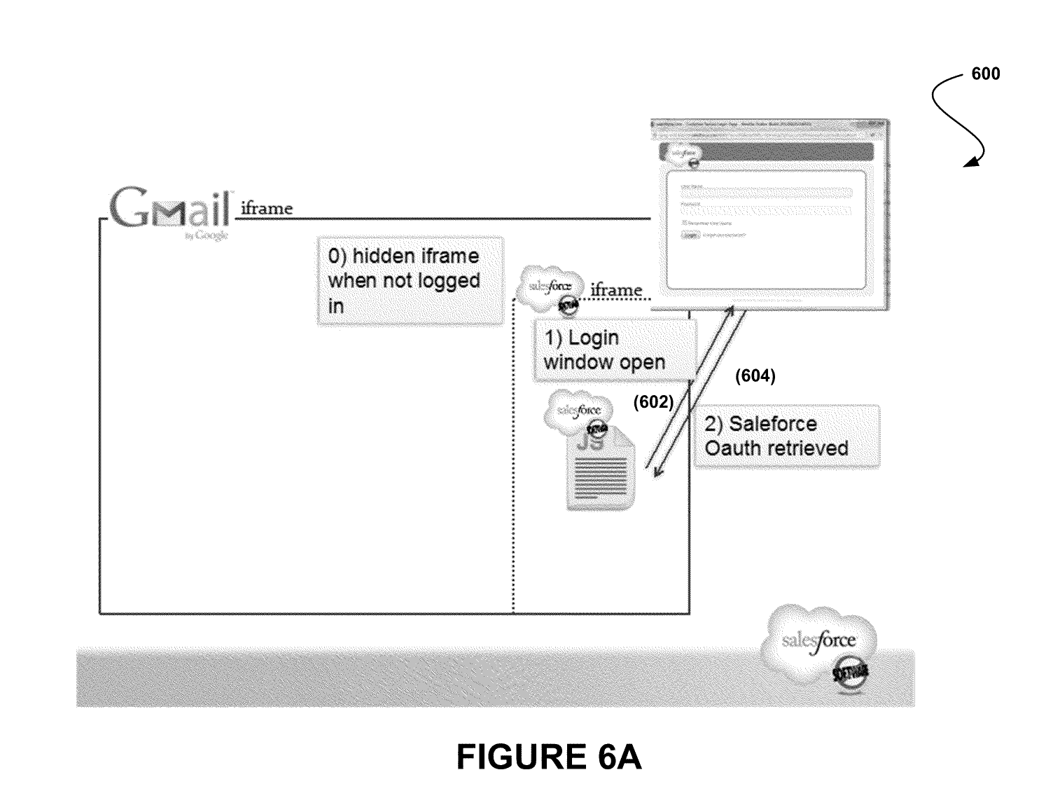

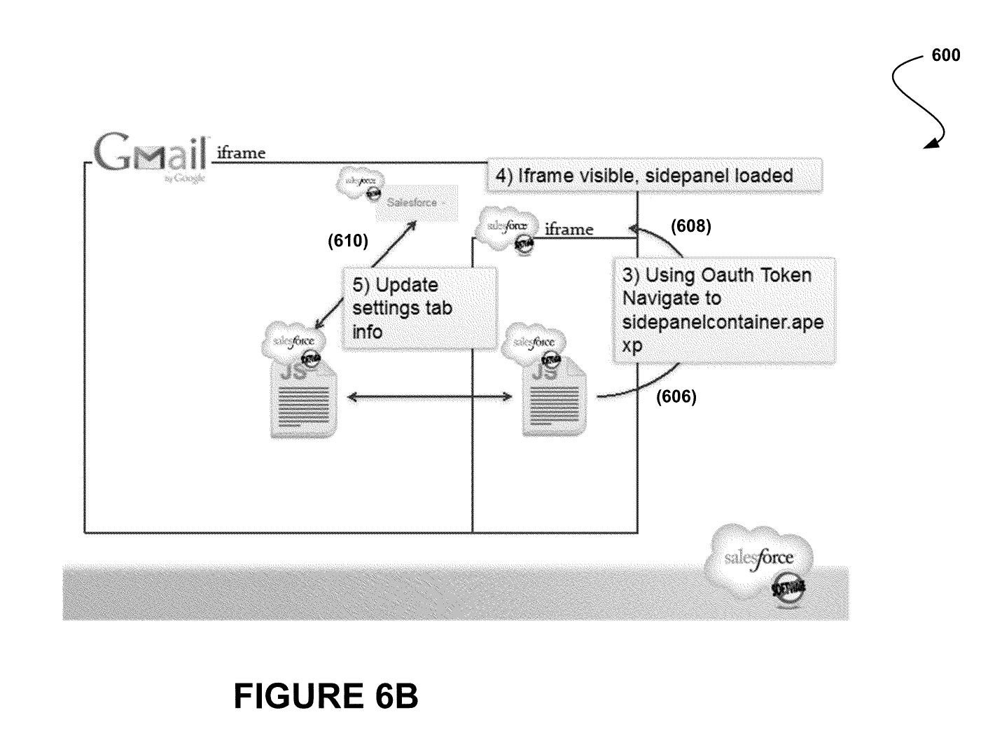

FIGS. 6A-B illustrate an operational flow diagram 600 for updating a settings tab of an email application, in accordance with FIG. 4. As shown in operation 602, a login window (e.g. of FIG. 5) is displayed via the email application for allowing the user to login to the multi-tenant database system. Further, an authorization token is retrieved in operation 604 via a component of the application, in response to the user successfully logging into the multi-tenant database system.

In operation 606 the authorization token is used as the basis for loading in operation 608 a pane in the email application for use in displaying records retrieved from the multi-tenant database system. In an embodiment, prior to receipt of the authorization token, the pane may be at least partially displayed for allowing the user to select an option to login to the multi-tenant database system. Thus, in response to the user selecting the login option, operation 602 may be initiated. In operation 610 a settings tab of the email application is updated to show the current user logged into the multi-tenant database system.

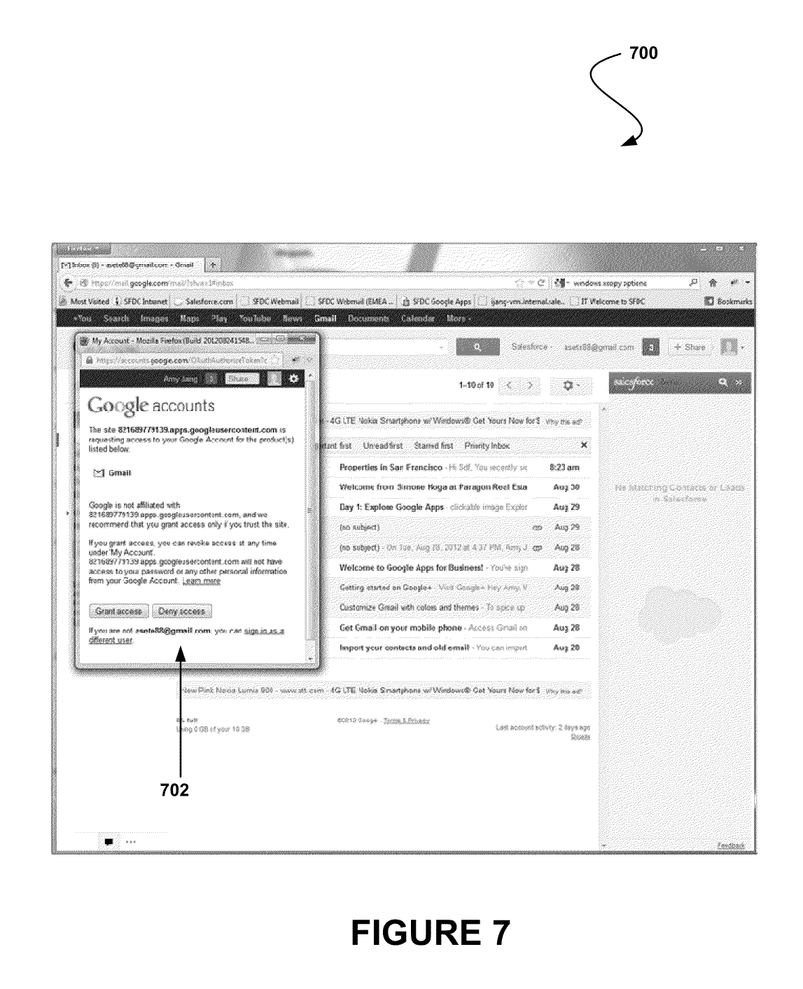

FIG. 7 illustrates an exemplary GUI 700 illustrating the authorization window of FIG. 4 displayed in association with an email application, in accordance with an embodiment. As shown, the authorization window 702 is displayed as a pop-up window presented over the interface of the email application. The authorization window 702 allows the user logged into the multi-tenant database system to authorize the integration of the email application with the multi-tenant database system. Once the integration is authorized, records accessible to the user based on predefined permissions (e.g. configured in the multi-tenant database system) may be retrieved from the multi-tenant database system in association with any email messages selected by the user.

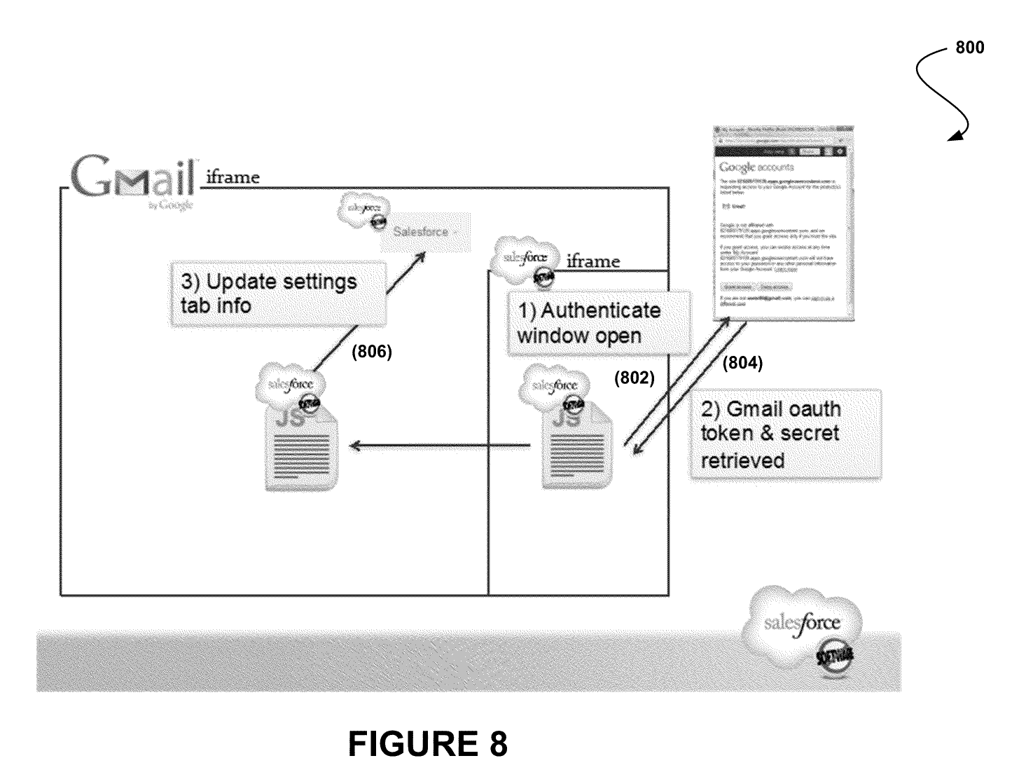

FIG. 8 illustrates an operational flow diagram 800 for updating a settings tab of an email application, in accordance with an embodiment. As an option, the present flow diagram 800 may be carried out in the context of FIGS. 1-7. Of course, however, the present flow diagram 800 may be carried out in any desired environment. It should also be noted that the aforementioned definitions may apply during the present description.

As shown in operation 802, a component of the email application opens an authorization window (e.g. item 702 of FIG. 7) for use in authorizing the integration of the email application with the multi-tenant database system. Upon a user selecting to authorize such integration, an authorization token is returned from a provider of the email application to the component, as shown in operation 804. The component then instructs another component of the email application to update the settings tab to show the current user logged into the multi-tenant database system, as shown in operation 806.

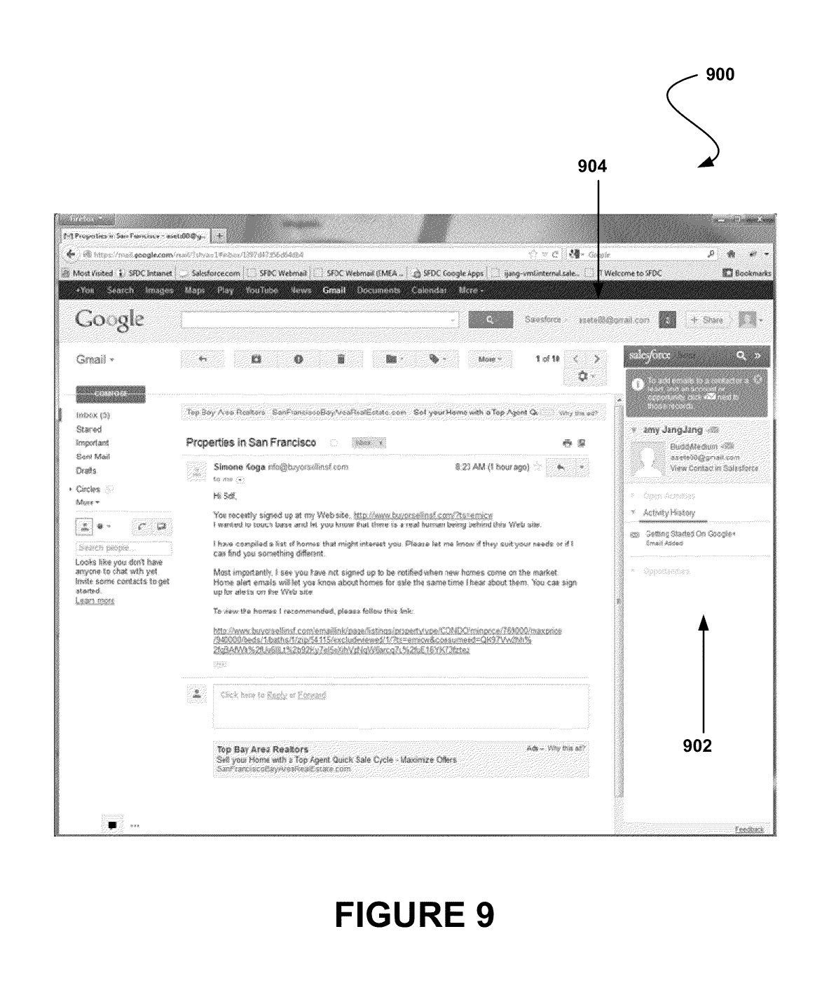

FIG. 9 illustrates an exemplary GUI 900 of an email application presenting details of records retrieved from a multi-tenant database system, in accordance with an embodiment. As an option, the GUI 900 may be implemented in the context of FIGS. 1-8. Of course, however, the GUI 900 may be implemented in any desired environment. It should also be noted that the aforementioned definitions may apply during the present description.

As shown, the GUI 900 includes a pane 902 presenting details of records retrieved from a multi-tenant database system for a selected item of information of the email application. The GUI 900 also includes a settings tab 904 showing a current user logged into the multi-tenant database system via the email application. The current user is shown in the settings tab 904 by presenting a login name used by the user to login to the multi-tenant database system via the email application.

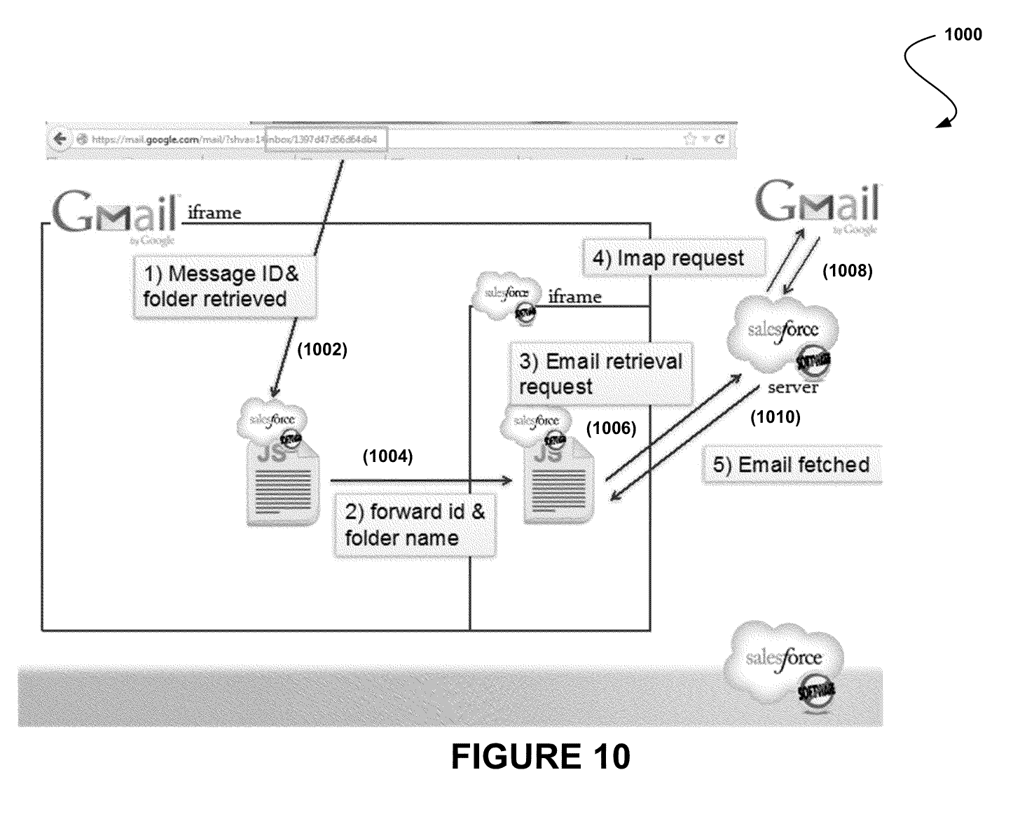

FIG. 10 illustrates an operational flow diagram 1000 for presenting an indication that an email of an email application has been stored in a multi-tenant database system, in accordance with an embodiment. As an option, the operational flow diagram 1000 may be implemented in the context of FIGS. 1-9. Of course, however, the operational flow diagram 1000 may be implemented in any desired environment. It should also be noted that the aforementioned definitions may apply during the present description.

In operation 1002, a identifier of an email message selected by the user in the email application is retrieved. The identifier may be any unique identifier for the email message. For example, as shown, the identifier may be a combination of a message ID and a name of a folder in which the message is stored by the email application. The identifier may be retrieved from a URL utilized to access the email message by a component of the email application.

In operation 1004, the retrieved identifier is forwarded to another component of the email application, which then uses the identifier to request the email from the multi-tenant database system, as shown in operation 1006. In operation 1008 multi-tenant database system forwards the request to a backend of the email application (e.g. a server storing the email) and in response receives the email message. In operation 1010 the multi-tenant database system provides to the other component of the email application the email message. Further, if the multi-tenant database system determines that the email message has previously been stored in the multi-tenant database system (i.e. in response to a user command), the multi-tenant database system may also provide to the other component in operation 1010 an indicator that the email message has previously been stored in the multi-tenant database system.

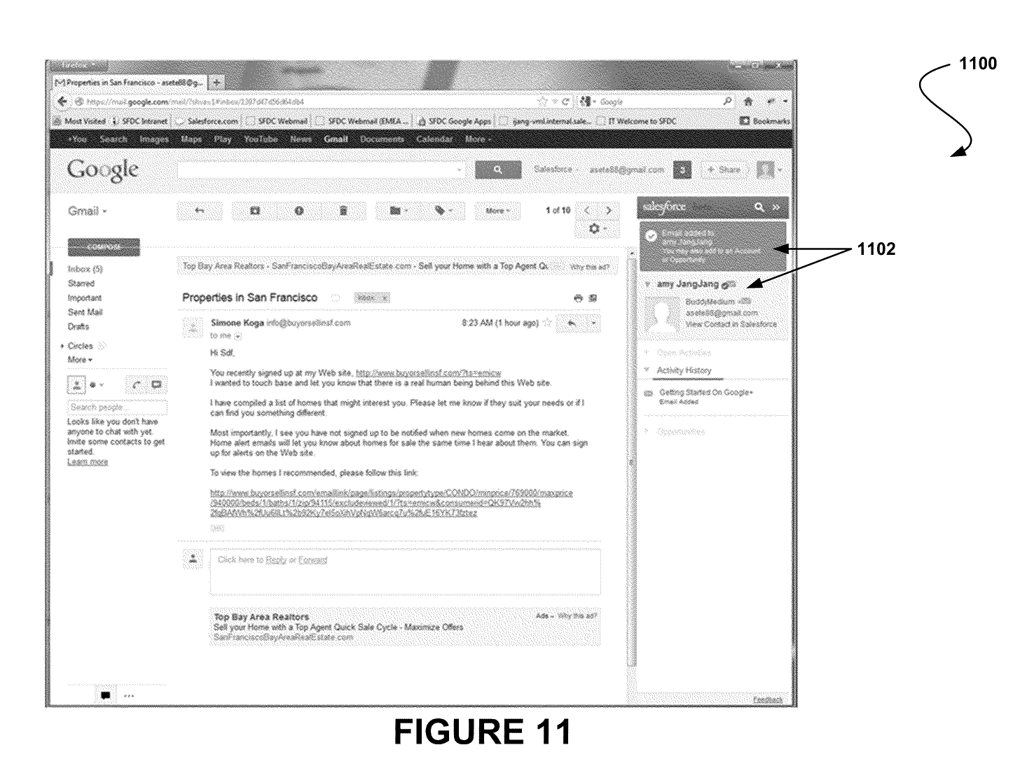

FIG. 11 illustrates an exemplary GUI 1100 of an email application presenting the indication of FIG. 10, in accordance with an embodiment. As shown, the GUI 1100 includes a pane for presenting details of records retrieved from the multi-tenant database system that are associated with one or more contacts of the selected email message. If the email message has been stored in association with any of those records, then an indicator 1102 of such storage is displayed in the GUI 1100 in association with the details of those records.

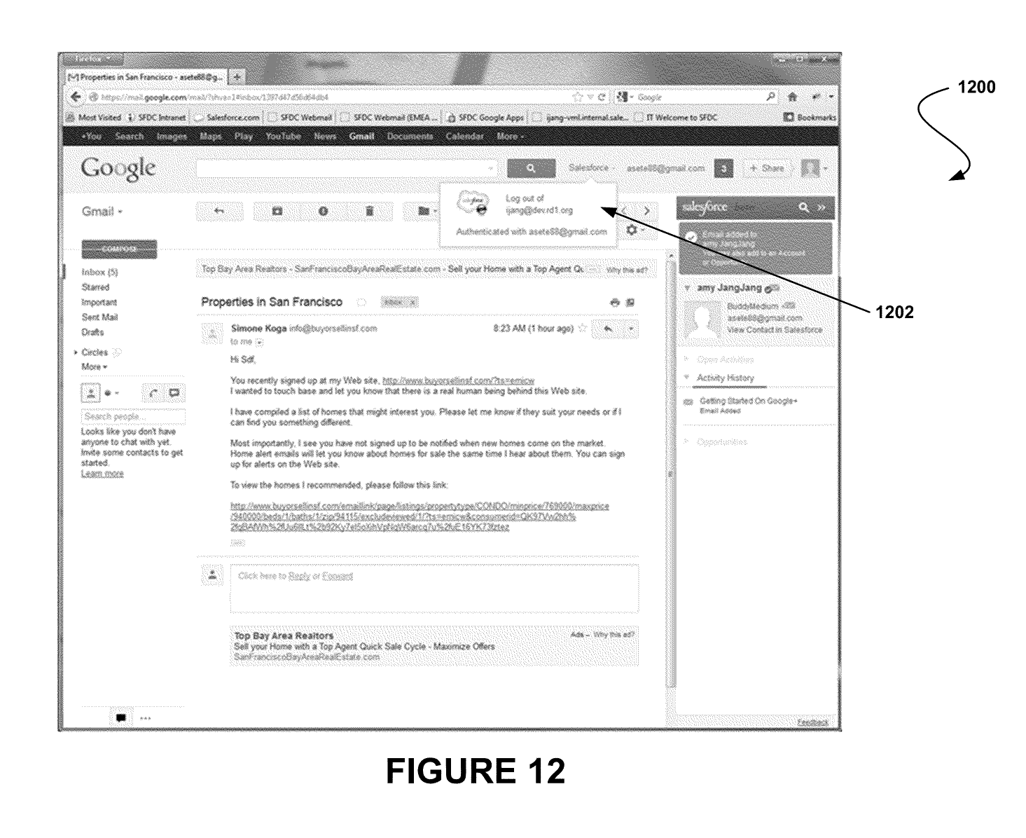

FIG. 12 illustrates an exemplary GUI 1200 of an email application presenting an indication of a user session with a multi-tenant database system, in accordance with an embodiment. As an option, the present GUI 1200 may be implemented in the context of FIGS. 1-11. Of course, however, the GUI 1200 may be implemented in any desired environment. It should also be noted that the aforementioned definitions may apply during the present description.

As shown, the GUI 1200 includes a settings tab 1202 showing a current user logged into (e.g. holding a session with) the multi-tenant database system via the email application. The settings tab 1202 displays a username of the user. The settings tab 1202 may also display a tenant (i.e. organization) of the multi-tenant database system with which the username is associated. For example, the username may be particular to a tenant of the multi-tenant database system, where the user is a subscriber of that tenant and the username represents a subscription to the multi-tenant database system in association with that tenant. The settings tab 1202 may also provide an option for the user to log out of the multi-tenant database system via the email application.

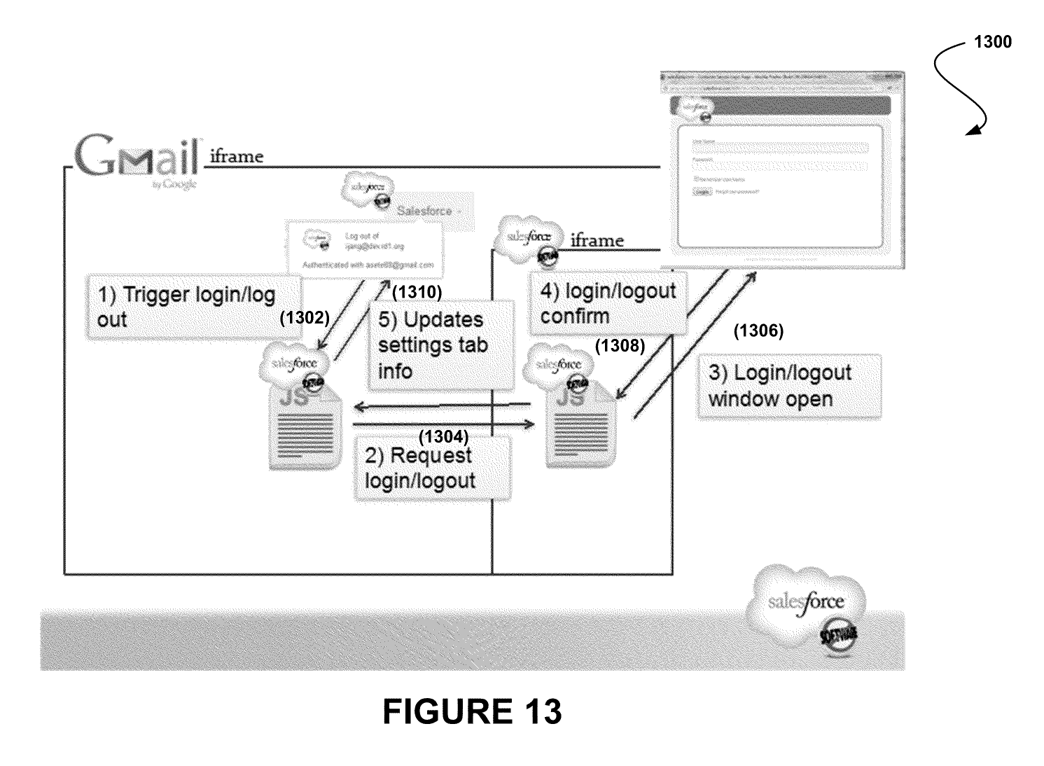

FIG. 13 illustrates an operational flow diagram 1300 for logging in/out of a multi-tenant database system via an email application, in accordance with an embodiment. As an option, the operational flow diagram 1300 may be carried out in the context of FIGS. 1-12. Of course, however, the operational flow diagram 1300 may be carried out in any desired environment. It should also be noted that the aforementioned definitions may apply during the present description.

As shown in operation 1302, a user logged into an email application selects to login to or logout of the multi-tenant database system via the email application. For example, the user may select an option of a settings tab of the email application to login to/logout of the multi-tenant database system. While the remaining operations are described with reference to the user logging out of the multi-tenant database system, it should be noted that a reverse workflow may be used when the user selects to login to the multi-tenant database system.

When the user selects to log out of the multi-tenant database system, a log out request from a first component of the email application (e.g. that is associated with the settings tab) is sent to a second component of the email application (e.g. that is associated with a logout window of the multi-tenant database system). Upon receipt of the request, the second component opens the logout window of the multi-tenant database system, as shown in operation 1308. For example, the second component may request a logout page of the multi-tenant database system.

Accordingly, the user may use that logout page to log out of the multi-tenant database system. Upon logging out, the second component of the email application receives in operation 1308 confirmation from the multi-tenant database system that the user successfully logged out of the multi-tenant database system. In response to receipt of the confirmation, as shown in operation 1310, the second component forwards the confirmation to the first component of the email application which then updates the settings tab to show that no user is currently logged into the multi-tenant database system via the email application. Once the user is no longer logged into the multi-tenant database system, the email application may be prevented from retrieving any records from the multi-tenant database system in association with email messages of the email application selected by the user.

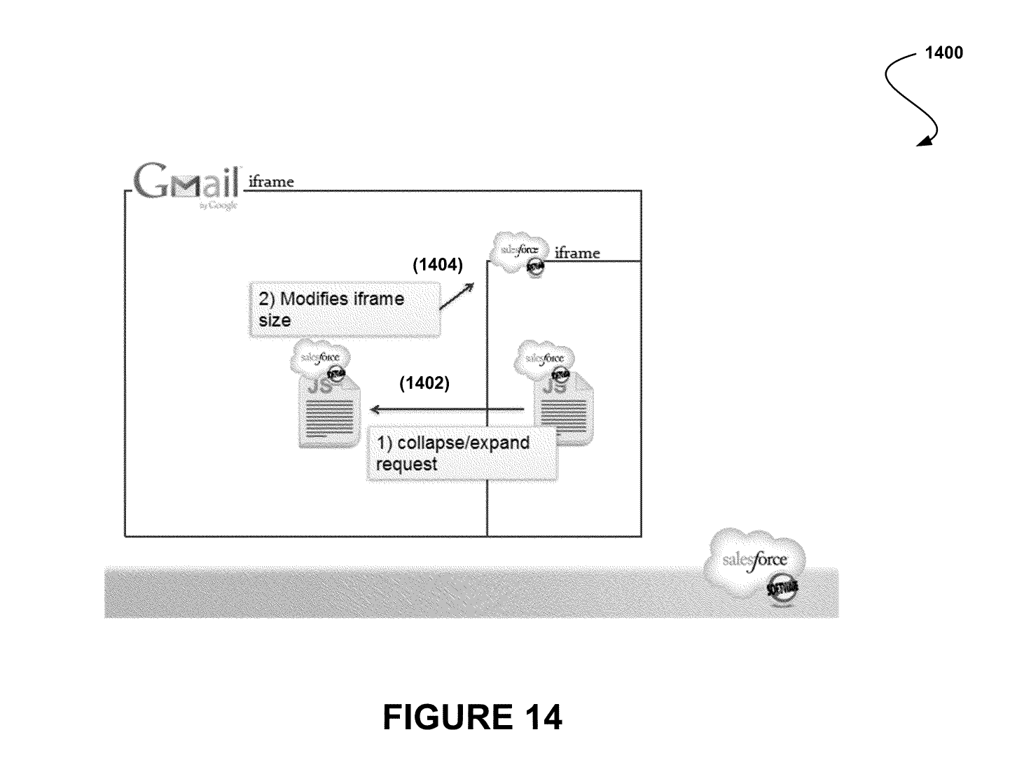

FIG. 14 illustrates an operational flow diagram 1400 for allowing a user to configure a portion of an email application presenting details of records retrieved from a multi-tenant database system, in accordance with an embodiment. As an option, the operational flow diagram 1400 may be implemented in the context of FIGS. 1-13. Of course, however, the operational flow diagram 1400 may be implemented in any desired environment. It should also be noted that the aforementioned definitions may apply during the present description.

In the present embodiment, a user selects to either collapse an expanded (i.e. displayed) pane used for presenting details of records retrieved from the multi-tenant database system, or selects to expand a collapsed (i.e. hidden) pane used for presenting details of records retrieved from the multi-tenant database system. In response to the user selection, a component of the email application associated with the pane sends a request to another component of the email application to modify a size of the pane, as shown in operation 1402. In operation 1404 the other component of the email application modifies the size of the pane as requested. Thus, a user selection to collapse the pane may result in the size of the pane being modified such that the pane is hidden, and a user selection to expand the pane may result in the size of the pane being modified such that the pane is displayed.

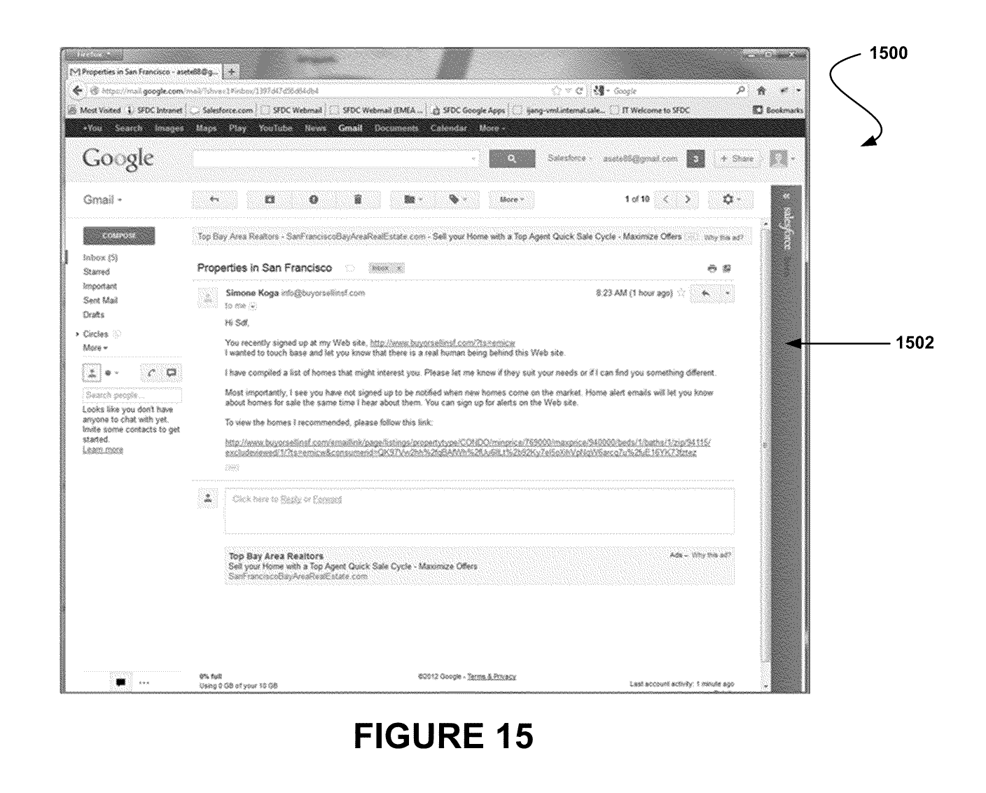

FIG. 15 illustrates an exemplary GUI 1500 of an email application resulting from a collapsing of the portion of the email application described in FIG. 14, in accordance with an embodiment. As shown, the GUI 1500 includes the hidden pane. The hidden pane may be accessible via a panel 1502, where upon selection of the panel by the user the hidden pane may be expanded. Optionally, when the pane is hidden, the email application may be prevented from retrieving records from the multi-tenant on-demand database system in association with any selected email messages.

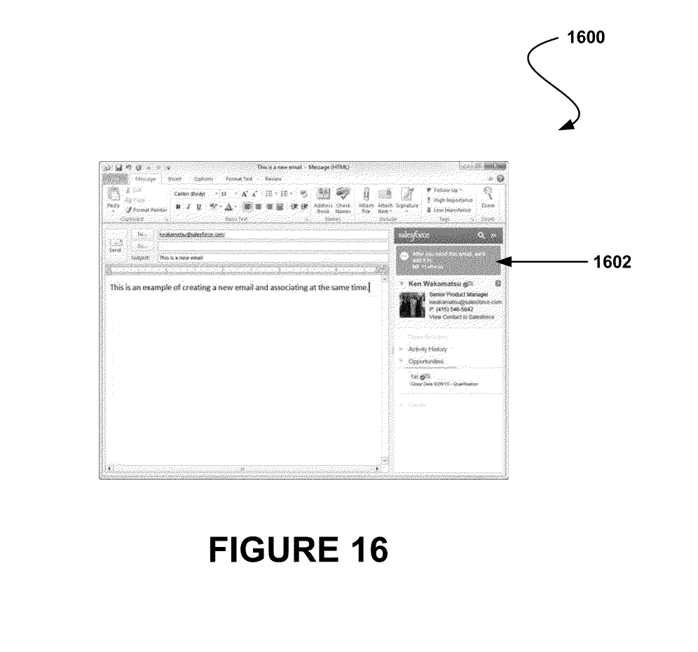

FIG. 16 illustrates an exemplary GUI 1600 of an email application for presenting an indication that an email of an email application will be automatically stored in a multi-tenant database system, in accordance with an embodiment. As an option, the GUI 1600 may be implemented in the context of FIGS. 1-15. Of course, however, the GUI 1600 may be implemented in any desired environment. It should also be noted that the aforementioned definitions may apply during the present description.

As shown, the GUI 1600 includes a pane for presenting details of records retrieved from the multi-tenant database system that are associated with one or more contacts of a newly composed email message. It should be noted that the GUI 1600 may also be included for email messages that are generated in response to replying to a received email message.

The GUI 1600 also includes an indication 1602 that the email message will be automatically stored in the multi-tenant database system upon the email being sent to the designated recipient. In particular, the email message will be automatically stored in association with one or all of the retrieved records.

In one exemplary embodiment, when the user selects to send the email message, the email message may be created in the multi-tenant database system as a task, the association(s) between the task and the record(s) may be made, and then the email application may send the email message to the designated recipient. When the email message has been stored in association with any of those records, then another GUI (not shown) presenting the sent email message (when selected) may include another indicator of such storage (see for example the indicator of the GUI 1100 of FIG. 11).

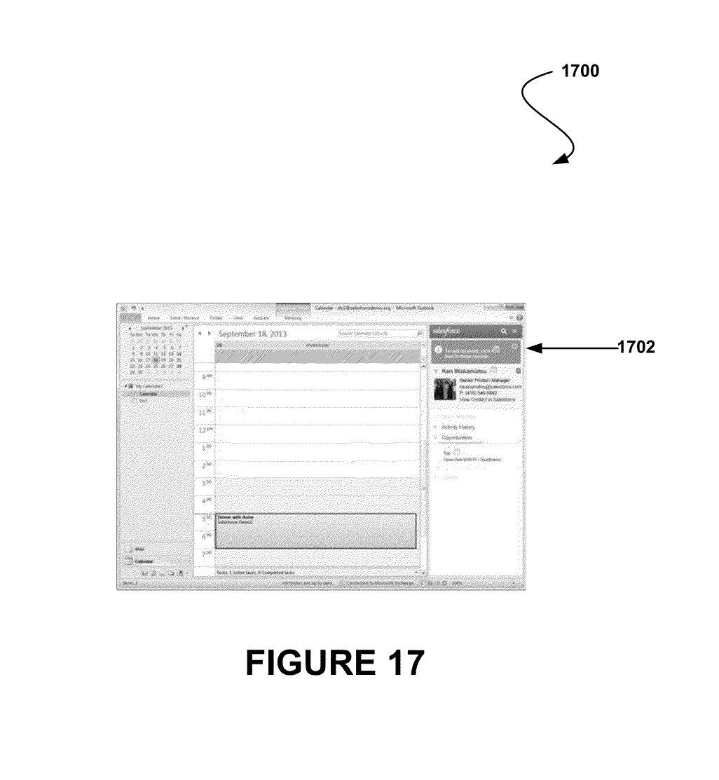

FIG. 17 illustrates an exemplary GUI 1700 of a calendar application for presenting an option for storing an event of the calendar application in a multi-tenant database system, in accordance with an embodiment. As an option, the GUI 1600 may be implemented in the context of FIGS. 1-15. Of course, however, the GUI 1600 may be implemented in any desired environment. It should also be noted that the aforementioned definitions may apply during the present description.

As shown, the GUI 1700 includes a pane for presenting details of records retrieved from the multi-tenant database system that are associated with one or more contacts of a selected event of the calendar application. For example, the event may be created or otherwise stored in the calendar application by the user of the calendar application.

The GUI 1700 also includes an indication 1702 that the selected event is capable of being stored in the multi-tenant database system in association with any of the retrieved records. In one embodiment, the selected event may be automatically stored in the multi-tenant database system. Further, the stored event may be conditionally synchronized with the multi-tenant database system.

For example, if the user has disabled the synchronization of events between the calendar application and the multi-tenant database system (e.g. using administrator settings, etc.), the above described pane of the GUI 1700 may store the event in association with any of the records of the multi-tenant database system that are associated with one or more contacts of the selected event of the calendar application, but the selected event may not be synchronized with the multi-tenant database system.

As another example, if the user has enabled the synchronization of events between the calendar application and the multi-tenant database system, the selected event may be created in the multi-tenant database system, and put it into a synchronization queue of the multi-tenant database system so that the event will match in the multi-tenant database system on a next event synchronization (e.g. every 15 minutes). If the user is on a manual synchronization then when a user relates the event in the multi-tenant database system it will also automatically be marked for synchronization.

### System Overview

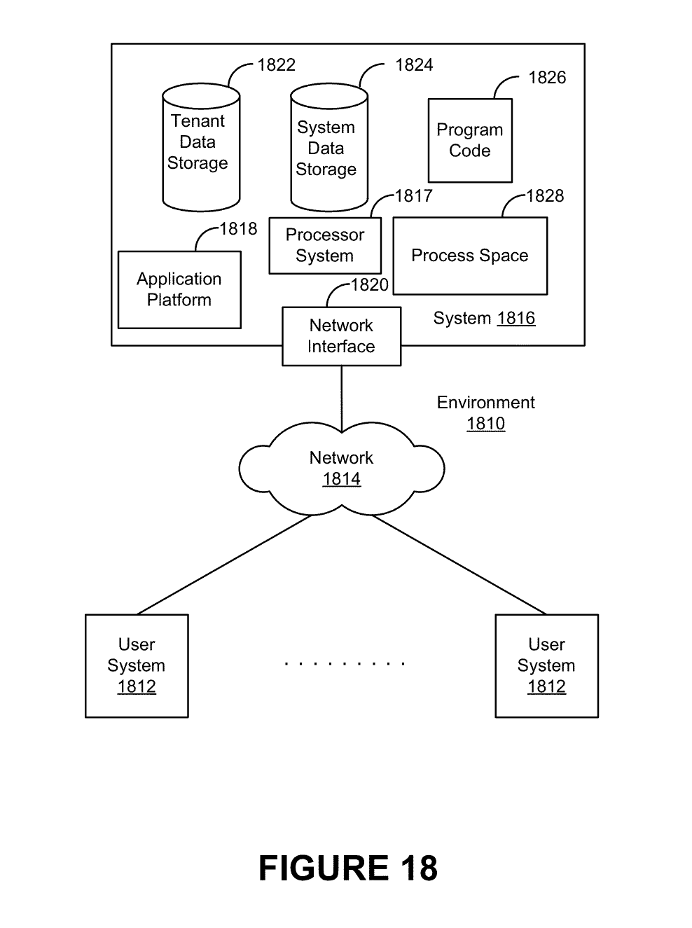

FIG. 18 illustrates a block diagram of an environment 1810 wherein an on-demand database service might be used. Environment 1810 may include user systems 1812, network 1814, system 1816, processor system 1817, application platform 1818, network interface 1820, tenant data storage 1822, system data storage 1824, program code 1826, and process space 1828. In other embodiments, environment 1810 may not have all of the components listed and/or may have other elements instead of, or in addition to, those listed above.

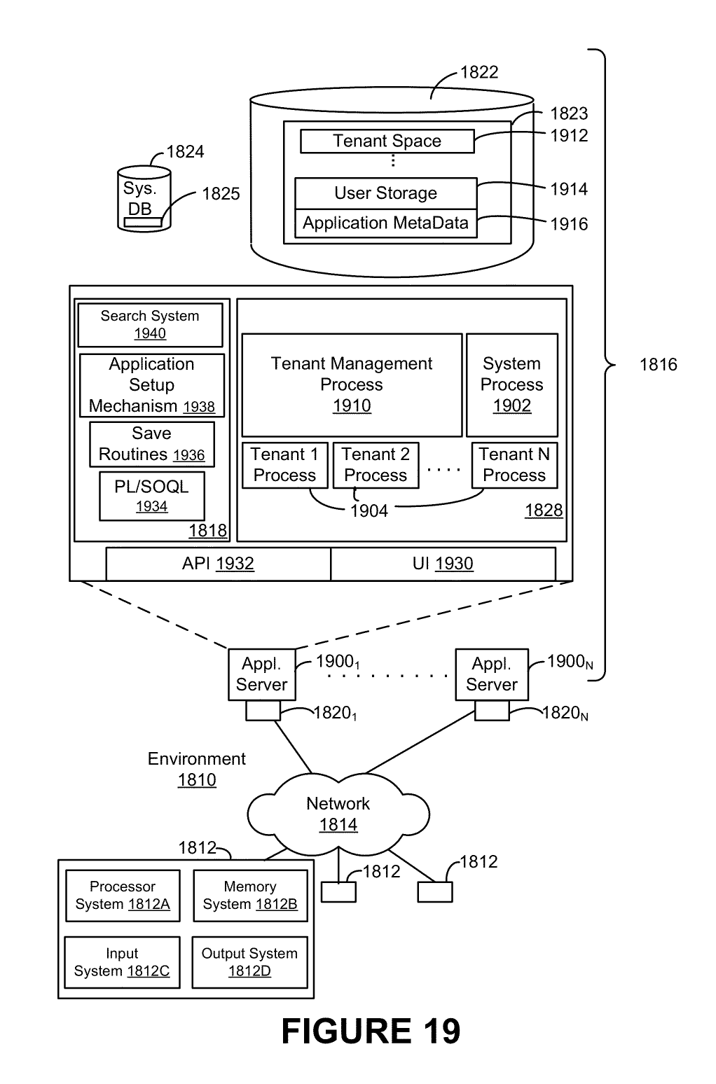

Environment 1810 is an environment in which an on-demand database service exists. User system 1812 may be any machine or system that is used by a user to access a database user system. For example, any of user systems 1812 can be a handheld computing device, a mobile phone, a laptop computer, a work station, and/or a network of computing devices. As illustrated in FIG. 18 (and in more detail in FIG. 19) user systems 1812 might interact via a network 1814 with an on-demand database service, which is system 1816.

An on-demand database service, such as system 1816, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 1816” and “system 1816” will be used interchangeably herein. A database image may include one or more database objects. A relational database management system (RDMS) or the equivalent may execute storage and retrieval of information against the database object(s). Application platform 1818 may be a framework that allows the applications of system 1816 to run, such as the hardware and/or software, e.g., the operating system. In an embodiment, on-demand database service 1816 may include an application platform 1818 that enables creation, managing and executing one or more applications developed by the provider of the on-demand database service, users accessing the on-demand database service via user systems 1812, or third party application developers accessing the on-demand database service via user systems 1812.

The users of user systems 1812 may differ in their respective capacities, and the capacity of a particular user system 1812 might be entirely determined by permissions (permission levels) for the current user. For example, where a salesperson is using a particular user system 1812 to interact with system 1816, that user system has the capacities allotted to that salesperson. However, while an administrator is using that user system to interact with system 1816, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 1814 is any network or combination of networks of devices that communicate with one another. For example, network 1814 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 1812 might communicate with system 1816 using TCP/IP and, at a higher network level, use other common Internet protocols to communicate, such as HTTP, FTP, AFS, WAP, etc. In an example where HTTP is used, user system 1812 might include an HTTP client commonly referred to as a “browser” for sending and receiving HTTP messages to and from an HTTP server at system 1816. Such an HTTP server might be implemented as the sole network interface between system 1816 and network 1814, but other techniques might be used as well or instead. In some implementations, the interface between system 1816 and network 1814 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 1816, shown in FIG. 18, implements a web-based customer relationship management (CRM) system. For example, in one embodiment, system 1816 includes application servers configured to implement and execute CRM software applications as well as provide related data, code, forms, webpages and other information to and from user systems 1812 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 1816 implements applications other than, or in addition to, a CRM application. For example, system 1816 may provide tenant access to multiple hosted (standard and custom) applications, including a CRM application. User (or third party developer) applications, which may or may not include CRM, may be supported by the application platform 1818, which manages creation, storage of the applications into one or more database objects and executing of the applications in a virtual machine in the process space of the system 1816.

One arrangement for elements of system 1816 is shown in FIG. 18, including a network interface 1820, application platform 1818, tenant data storage 1822 for tenant data 1823, system data storage 1824 for system data 1825 accessible to system 1816 and possibly multiple tenants, program code 1826 for implementing various functions of system 1816, and a process space 1828 for executing MTS system processes and tenant-specific processes, such as running applications as part of an application hosting service. Additional processes that may execute on system 1816 include database indexing processes.

Several elements in the system shown in FIG. 18 include conventional, well-known elements that are explained only briefly here. For example, each user system 1812 could include a desktop personal computer, workstation, laptop, PDA, cell phone, or any wireless access protocol (WAP) enabled device or any other computing device capable of interfacing directly or indirectly to the Internet or other network connection. User system 1812 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 1812 to access, process and view information, pages and applications available to it from system 1816 over network 1814. Each user system 1812 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1816 or other systems or servers. For example, the user interface device can be used to access data and applications hosted by system 1816, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 1812 and all of its components are operator configurable using applications, such as a browser, including computer code run using a central processing unit such as an Intel Pentium® processor or the like. Similarly, system 1816 (and additional instances of an MTS, where more than one is present) and all of their components might be operator configurable using application(s) including computer code to run using a central processing unit such as processor system 1817, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 1816 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 1816 is configured to provide webpages, forms, applications, data and media content to user (client) systems 1812 to support the access by user systems 1812 as tenants of system 1816. As such, system 1816 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 19 also illustrates environment 1810. However, in FIG. 19 elements of system 1816 and various interconnections in an embodiment are further illustrated. FIG. 19 shows that user system 1812 may include processor system 1812A, memory system 1812B, input system 1812C, and output system 1812D. FIG. 19 shows network 1814 and system 1816. FIG. 19 also shows that system 1816 may include tenant data storage 1822, tenant data 1823, system data storage 1824, system data 1825, User Interface (UI) 1930, Application Program Interface (API) 1932, PL/SOQL 1934, save routines 1936, application setup mechanism 1938, applications servers 1900₁-1900_{N}, system process space 1902, tenant process spaces 1904, tenant management process space 1910, tenant storage area 1912, user storage 1914, and application metadata 1916. In other embodiments, environment 1810 may not have the same elements as those listed above and/or may have other elements instead of, or in addition to, those listed above.

User system 1812, network 1814, system 1816, tenant data storage 1822, and system data storage 1824 were discussed above in FIG. 18. Regarding user system 1812, processor system 1812A may be any combination of one or more processors. Memory system 1812B may be any combination of one or more memory devices, short term, and/or long term memory. Input system 1812C may be any combination of input devices, such as one or more keyboards, mice, trackballs, scanners, cameras, and/or interfaces to networks. Output system 1812D may be any combination of output devices, such as one or more monitors, printers, and/or interfaces to networks. As shown by FIG. 19, system 1816 may include a network interface 1820 (of FIG. 18) implemented as a set of HTTP application servers 1900, an application platform 1818, tenant data storage 1822, and system data storage 1824. Also shown is system process space 1902, including individual tenant process spaces 1904 and a tenant management process space 1910. Each application server 1900 may be configured to tenant data storage 1822 and the tenant data 1823 therein, and system data storage 1824 and the system data 1825 therein to serve requests of user systems 1812. The tenant data 1823 might be divided into individual tenant storage areas 1912, which can be either a physical arrangement and/or a logical arrangement of data. Within each tenant storage area 1912, user storage 1914 and application metadata 1916 might be similarly allocated for each user. For example, a copy of a user's most recently used (MRU) items might be stored to user storage 1914. Similarly, a copy of MRU items for an entire organization that is a tenant might be stored to tenant storage area 1912. A UI 1930 provides a user interface and an API 1932 provides an application programmer interface to system 1816 resident processes to users and/or developers at user systems 1812. The tenant data and the system data may be stored in various databases, such as one or more Oracle™ databases.

Application platform 1818 includes an application setup mechanism 1938 that supports application developers' creation and management of applications, which may be saved as metadata into tenant data storage 1822 by save routines 1936 for execution by subscribers as one or more tenant process spaces 1904 managed by tenant management process 1910 for example. As an option, the application platform 1818 may further include a search system 1840. Invocations to such applications may be coded using PL/SOQL 1934 that provides a programming language style interface extension to API 1932. A detailed description of some PL/SOQL language embodiments is discussed in commonly owned U.S. Pat. No. 7,730,478, entitled “METHOD AND SYSTEM FOR ALLOWING ACCESS TO DEVELOPED APPLICATIONS VIA A MULTI-TENANT ON-DEMAND DATABASE SERVICE,” issued Jun. 1, 2010 to Craig Weissman, hereby incorporated in its entirety herein for all purposes. Invocations to applications may be detected by one or more system processes, which manages retrieving application metadata 1916 for the subscriber making the invocation and executing the metadata as an application in a virtual machine.

Each application server 1900 may be communicably coupled to database systems, e.g., having access to system data 1825 and tenant data 1823, via a different network connection. For example, one application server 1900₁ might be coupled via the network 1814 (e.g., the Internet), another application server 1900_{N-1} might be coupled via a direct network link, and another application server 1900_{N} might be coupled by yet a different network connection. Transfer Control Protocol and Internet Protocol (TCP/IP) are typical protocols for communicating between application servers 1900 and the database system. However, it will be apparent to one skilled in the art that other transport protocols may be used to optimize the system depending on the network interconnect used.

In certain embodiments, each application server 1900 is configured to handle requests for any user associated with any organization that is a tenant. Because it is desirable to be able to add and remove application servers from the server pool at any time for any reason, there is preferably no server affinity for a user and/or organization to a specific application server 1900. In one embodiment, therefore, an interface system implementing a load balancing function (e.g., an F5 Big-IP load balancer) is communicably coupled between the application servers 1900 and the user systems 1812 to distribute requests to the application servers 1900. In one embodiment, the load balancer uses a least connections algorithm to route user requests to the application servers 1900. Other examples of load balancing algorithms, such as round robin and observed response time, also can be used. For example, in certain embodiments, three consecutive requests from the same user could hit three different application servers 1900, and three requests from different users could hit the same application server 1900. In this manner, system 1816 is multi-tenant, wherein system 1816 handles storage of, and access to, different objects, data and applications across disparate users and organizations.

As an example of storage, one tenant might be a company that employs a sales force where each salesperson uses system 1816 to manage their sales process. Thus, a user might maintain contact data, leads data, customer follow-up data, performance data, goals and progress data, etc., all applicable to that user's personal sales process (e.g., in tenant data storage 1822). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1816 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1816 might also maintain system level data usable by multiple tenants or other data. Such system level data might include industry reports, news, postings, and the like that are sharable among tenants.

In certain embodiments, user systems 1812 (which may be client systems) communicate with application servers 1900 to request and update system-level and tenant-level data from system 1816 that may require sending one or more queries to tenant data storage 1822 and/or system data storage 1824. System 1816 (e.g., an application server 1900 in system 1816) automatically generates one or more SQL statements (e.g., one or more SQL queries) that are designed to access the desired information. System data storage 1824 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled “CUSTOM ENTITIES AND FIELDS IN A MULTI-TENANT DATABASE SYSTEM”, issued Aug. 27, 2010 to Craig Weissman, and hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method, the method comprising:
receiving a user selected item of information from an application utilized for managing information of the user;
identifying a contact from the user selected item of information;
retrieving, from a multi-tenant database system separate from the application, at least one record related to the contact;
presenting details of each retrieved record in association with the application;
receiving a command from the user to store the item of information in the multi-tenant database system in association with at least one of the retrieved records; and
presenting, in association with the details of the at least one of the retrieved records, an indication of the storage of the item of information in the multi-tenant database system.

2. The computer program product of claim 1, wherein the application is an email application.

3. The computer program product of claim 2, wherein the item of information is an email stored by the email application.

4. The computer program product of claim 1, wherein the application is a calendar.

5. The computer program product of claim 4, wherein the item of information is a task stored by the calendar.

6. The computer program product of claim 1, wherein the application is a contact directory.

7. The computer program product of claim 6, wherein the item of information is a contact entry in the contact directory.

8. The computer program product of claim 1, wherein the contact is an email address included in the item of information.

9. The computer program product of claim 1, wherein the contact is a name included in the item of information.

10. The computer program product of claim 1, wherein the at least one record related to the contact is retrieved by querying the multi-tenant database system using the contact.

11. The computer program product of claim 1, wherein the at least one retrieved record is one or more of a contact record storing information of the contact, an activity record storing a task of the contact, and an opportunity record storing information of another contact that is associated with the contact.

12. The computer program product of claim 1, wherein a graphical user interface (GUI) of the application presents the item of information in a first portion of the GUI and the details of the retrieved records in a second portion of the GUI.

13. The computer program product of claim 1, further comprising storing the item of information in the multi-tenant database system in association with at least one of the retrieved records, in response to receipt of the command.

14. The computer program product of claim 13, wherein for each subsequent selection of the item of information by the user, identifying in the multi-tenant database system the association with the at least one of the retrieved records and presenting the indication of the storage of the item of information in association with the item of information.

15. The computer program product of claim 1, further comprising logging in the user to the multi-tenant database system, via the application.

16. The computer program product of claim 15, further comprising presenting an authorization window in association with the application, to authorize integration of the email application with the multi-tenant database system.

17. The computer program product of claim 15, wherein the application includes a settings tab for showing when the user is currently logged into the multi-tenant database system.

18. The computer program product of claim 15, wherein only records accessible to the user based on predefined permissions are retrieved from the multi-tenant database system.

19. A method, comprising:
receiving a user selected item of information from an application utilized for managing information of the user;
identifying a contact from the user selected item of information;
retrieving, from a multi-tenant database system separate from the application, at least one record related to the contact, utilizing a processor;
presenting details of each retrieved record in association with the application;
receiving a command from the user to store the item of information in the multi-tenant database system in association with at least one of the retrieved records; and
presenting, in association with the details of the at least one of the retrieved records, an indication of the storage of the item of information in the multi-tenant database system.

20. An apparatus, comprising:
a processor for:
receiving a user selected item of information from an application utilized for managing information of the user;
identifying a contact from the user selected item of information;
retrieving, from a multi-tenant database system separate from the application, at least one record related to the contact;
presenting details of each retrieved record in association with the application;
receiving a command from the user to store the item of information in the multi-tenant database system in association with at least one of the retrieved records; and
presenting, in association with the details of the at least one of the retrieved records, an indication of the storage of the item of information in the multi-tenant database system.

21. A method for transmitting code, comprising:
transmitting code for receiving a user selected item of information from an application utilized for managing information of the user;
transmitting code for identifying a contact from the user selected item of information;
transmitting code for retrieving, from a multi-tenant database system separate from the application, at least one record related to the contact, utilizing a processor;
transmitting code for presenting details of each retrieved record in association with the application;
transmitting code for receiving a command from the user to store the item of information in the multi-tenant database system in association with at least one of the retrieved records; and
transmitting code for presenting, in association with the details of the at least one of the retrieved records, an indication of the storage of the item of information in the multi-tenant database system.
